(19) United States
(12) Patent Application Publication
(10) Pub. No.: US 2025/0264774 A1
(43) Pub. Date: Aug. 21, 2025

(54) OPTICAL APPARATUS AND CAMERA SYSTEM

(71) Applicant: CANON KABUSHIKI KAISHA, Tokyo (JP)

(72) Inventors: KENTA TAKAI, Kanagawa (JP); TOSHIHIRO OGAWA, Tokyo (JP); TADANORI OKADA, Tochigi (JP); HYOCHORU TANAKA, Tochigi (JP); KENTA KOIWAI, Tochigi (JP)

(21) Appl. No.: 18/983,753

(22) Filed: Dec. 17, 2024

(30) Foreign Application Priority Data
Feb. 15, 2024 (JP) 2024-020803

(51) Int. Cl. G03B 3/10; G03B 17/14

(52) U.S. Cl. CPC G03B 3/10; G03B 17/14; G03B 2205/0015

(57) ABSTRACT

An optical apparatus includes a holding member configured to hold an optical system, a drive unit configured to move the holding member, an intermediate member including a first intermediate member in contact with the drive unit, and a second intermediate member in contact with the first intermediate member and the holding member, the intermediate member being configured to transmit a drive force of the drive unit to the holding member, and a first biasing member configured to bias the first intermediate member toward the drive unit and bias the second intermediate member toward the holding member.

### BACKGROUND

### Technical Field

The present disclosure relates to an optical apparatus and a camera system.

### Description of Related Art

Improved portability has recently been demanded in carrying an optical apparatus such as a digital camera, a video camera, and an interchangeable lens. Japanese Patent Laid-Open No. 2012-150368 discloses a structure that reduces an overall length in a retracted state in which at least a part of a plurality of lens units is retracted to store the lens units by narrowing a moving range of a focus lens holding frame in particular.

The structure of Japanese Patent Laid-Open No. 2012-150368 can bias the focus lens holding frame in a direction parallel to an optical axis, but cannot bias it in a planar direction orthogonal to the optical axis. Therefore, the lens holding accuracy and finally the quality of a captured image may deteriorate.

### SUMMARY

An optical apparatus according to one aspect of the disclosure includes a holding member configured to hold an optical system, a drive unit configured to move the holding member, an intermediate member including a first intermediate member in contact with the drive unit, and a second intermediate member in contact with the first intermediate member and the holding member, the intermediate member being configured to transmit a drive force of the drive unit to the holding member, and a first biasing member configured to bias the first intermediate member toward the drive unit and bias the second intermediate member toward the holding member. A camera system having the above optical apparatus also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B are perspective views of a camera system according to a first embodiment.

FIG. 2 is a block diagram of the camera system according to the first embodiment.

FIG. 3 is a sectional view of an interchangeable lens at a wide-angle end during imaging in the first embodiment.

FIG. 4 is a sectional view of the interchangeable lens at a telephoto end during imaging in the first embodiment.

FIG. 5 is a sectional view of the interchangeable lens at a retracted end during non-imaging in the first embodiment.

FIGS. 6A and 6B are a perspective view and an exploded perspective view of a retractable structure according to the first embodiment.

FIG. 7 is a front view of the retractable structure according to the first embodiment.

FIG. 8 is a sectional view of the retractable structure according to the first embodiment at a telephoto end and at a close distance.

FIG. 9 is a sectional view of the retractable structure according to the first embodiment at the retracted end.

FIG. 10 is a perspective view illustrating a holding structure for a focus unit at the telephoto end in the first embodiment.

FIG. 11 is a perspective view illustrating the holding structure for the focus unit at the retracted end in the first embodiment.

FIG. 12 is a front perspective view illustrating the holding structure for the focus unit in the first embodiment.

FIG. 13 is a sectional view illustrating a holding structure for a rack according to the first embodiment.

FIG. 14 is a perspective view illustrating a lens mount according to the first embodiment from the object side.

FIG. 15 is a perspective view illustrating a holding structure for a focus unit at a telephoto end in a second embodiment.

FIG. 16 is a perspective view illustrating the holding structure for the focus unit at a retracted end in the second embodiment.

FIG. 17 is a front perspective view illustrating the holding structure for the focus unit in the second embodiment.

FIG. 18 is a sectional view illustrating the holding structure for the rack of the second embodiment.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

### First Embodiment

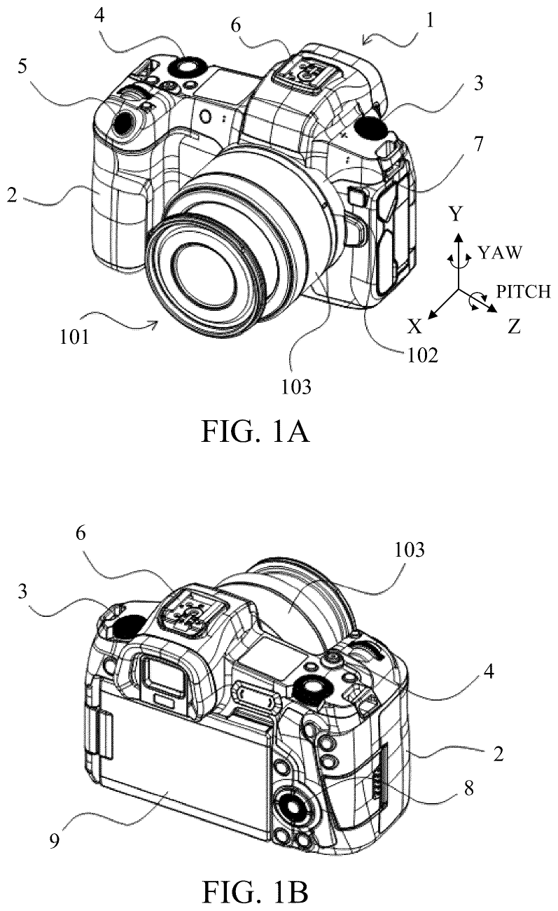

FIGS. 1A and 1B are perspective views of a camera system (image pickup apparatus) according to this embodiment. The camera system includes an interchangeable lens 101, and a digital camera (hereinafter referred to as a camera body) 1 to which the interchangeable lens 101 is detachably attached. FIGS. 1A and 1B are perspective views viewed from the front side (object side) and the back side (imaging surface side), respectively. This embodiment will describe the interchangeable lens 101, which is an example of an optical apparatus, but the present disclosure is also applicable to a lens integrated camera and the like.

In this embodiment, as illustrated in FIG. 1A, an optical axis direction as a direction in which the optical axis of the imaging optical system housed in the interchangeable lens 101 extends (a direction along the optical axis) is defined as an X-axis direction, and a directions orthogonal to the X-axis direction are defined as a Z-axis direction (horizontal direction) and a Y-axis direction (vertical direction). The Z-axis direction and the Y-axis direction will be collectively referred to as a Z/Y-axis direction. A rotational direction around the Z-axis will be defined as a pitch direction, and a rotational direction around the Y-axis will be defined as a yaw direction. The pitch direction and yaw direction (collectively referred to as pitch/yaw direction hereinafter) will be rotational directions around two orthogonal axes, the Z-axis and the Y-axis.

On the left side of the camera body 1 when viewed from the front (on the right side when viewed from the rear), a grip portion 2 is provided for the user to hold the camera body 1 with his hand. A power operation unit 3 is disposed on the top surface of the camera body 1. When the user turns on the power operation unit 3 while the camera body 1 is powered off, electrification is started and the camera body 1 transitions to a power-on state, and a computer program such as an origin detecting processing for the focus unit is executed, and the camera is in a standby state for imaging. When it is detected that the interchangeable lens 101 is mechanically and electrically connected while the camera body 1 is powered off, electrification is started from the camera body 1 and the origin detecting processing for the focus unit is executed. On the other hand, when the user turns off the power operation unit 3 while the camera body 1 is powered on, the camera body 1 transitions to a power-off state.

Provided on the top of the camera body 1 are a mode dial 4, a release button 5, and an accessory shoe 6. The user can switch between imaging modes by rotating the mode dial 4. The imaging modes include a manual still image capturing mode in which the user can arbitrarily set an imaging condition such as a shutter speed and an aperture value (F-number), an automatic still image capturing mode in which a proper exposure is automatically obtained, and a moving image capturing mode for capturing a moving image. The user can also instruct an imaging preparation operation such as autofocus (AF) and auto-exposure (AE) control by half-pressing the release button 5, and can instruct imaging by fully pressing the release button 5. An accessory (camera accessory) such as an external flash or other illumination or light emitting apparatus is detachably attached to the accessory shoe 6.

The interchangeable lens 101 includes a lens mount (fixed member) 102 that can be mechanically and electrically connected to a camera mount 7 provided on the camera body 1. The interchangeable lens 101 includes an imaging optical system configured to form an object image using light from an object. A zoom operation ring (operation member) 103 that can be rotated around the optical axis by a user operation is provided on the outer circumference of the interchangeable lens 101. In a case where the zoom operation ring 103 is rotated by the user, the zoom unit constituting the imaging optical system moves to a predetermined use position corresponding to an angle of the zoom operation ring 103 within a range from a wide-angle end to a telephoto end. Due to this configuration, the user can perform imaging at a desired angle of view. In this embodiment, a retracted end is provided to the zoom operation ring 103 that has been rotated from the telephoto end to the wide-angle end, which will be described in detail later, where the imaging is further restricted. The retracted end is a position where the interchangeable lens 101 is most retracted.

A rear operation unit 8 and a display unit 9 are provided on the rear surface of the camera body 1. The rear operation unit 8 includes a number of buttons and dials to which various functions are assigned. In a case where the camera body 1 is powered on and the still image capturing mode or the moving image capturing mode is set, the display unit 9 displays a through-image of an object image captured by an image sensor, which will be described later. The display unit 9 also displays imaging parameters indicating imaging conditions such as a shutter speed and an aperture value, and the user can change a set value of the imaging parameter by operating the rear operation unit 8 while checking the display. The rear operation unit 8 includes a playback button for instructing playback of a recorded captured image, and the captured image is played back and displayed on the display unit 9 in a case where the user operates the playback button. The display unit 9 may be of a touch panel type and have the same functions as the rear operation unit 8.

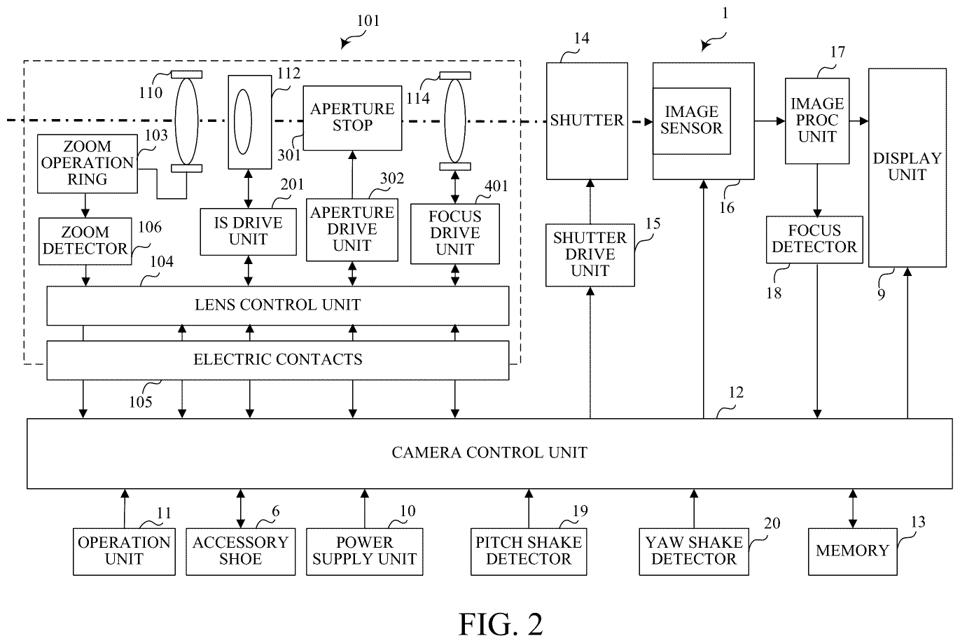

FIG. 2 is a block diagram illustrating the electrical and optical configuration of the camera system. The camera body 1 includes a power supply unit 10 that supplies power to the camera body 1 and the interchangeable lens 101, and an operation unit 11 that includes the power operation unit 3, the mode dial 4, the release button 5, the rear operation unit 8, and the touch panel function of the display unit 9. The entire camera system is controlled by a camera control unit 12 provided in the camera body 1 and a lens control unit 104 provided in the interchangeable lens 101 in cooperation with each other. The camera control unit 12 reads out and executes a computer program stored in a memory 13. At that time, the camera control unit 12 communicates various control signals, data, and the like with the lens control unit 104 via a communication terminal in electrical contacts 105 provided in the lens mount 102. The electrical contacts 105 include a power supply terminal that supplies power from the power supply unit 10 to the interchangeable lens 101.

The imaging optical system in the interchangeable lens 101 includes a zoom unit 110 that is connected to the zoom operation ring 103 and moves in the optical axis direction to change an angle of view, and a lens image-stabilizing unit 112 that includes a shift lens as an image stabilizing element that performs image stabilization or reduces image blur. The lens image-stabilizing unit 112 performs an image stabilizing operation to reduce image blur by moving (shifting) the shift lens in a direction including Z/Y-axis components orthogonal to the optical axis. The imaging optical system also includes an aperture (stop) unit 301 that performs a light amount adjusting operation, and a focus unit (optical system) 114 that includes a focus lens that moves in the optical axis direction for focusing. The interchangeable lens 101 includes an image stabilizing (IS) drive unit 201 that drives the lens image-stabilizing unit 112 to shift the shift lens, an aperture drive unit 302 that drives the aperture unit 301, and a focus drive unit 401 that drives the focus unit 114 to move the focus lens.

The camera body 1 includes a shutter unit 14, a shutter drive unit 15, an image sensor 16, an image processing unit 17, and a camera control unit 12. The shutter unit 14 controls a light amount that is collected by the imaging optical system in the interchangeable lens 101 and exposed by the image sensor 16. The image sensor 16 photoelectrically converts an object image formed by the imaging optical system and outputs an imaging signal. The image processing unit 17 generates an image signal after performing various image processing for the imaging signal. The display unit 9 displays the image signal (through-image) output from the image processing unit 17, displays the imaging parameter, and plays back and displays a captured image recorded in the memory 13 or an unillustrated recording medium.

The camera control unit 12 controls the focus drive unit 401 in accordance with an imaging preparation operation (such as half-pressing of the release button 5) on the operation unit 11. For example, in a case where an AF operation is instructed, the focus detector 18 determines a focus state of an object image formed by the image sensor 16 based on the image signal generated by the image processing unit 17, generates a focus signal, and sends it to the camera control unit 12. At the same time, the focus drive unit 401 sends information about the current position of the focus unit 114 to the camera control unit 12. The camera control unit 12 compares the focus state of the object image with the current position of the focus unit 114, calculates the focus driving amount from a shift amount, and sends it to the lens control unit 104. The lens control unit 104 then moves the focus unit 114 to a target position in the optical axis direction via the focus drive unit 401, and corrects the focus shift of the object image.

The details will be described later, but the focus drive unit 401 includes a focus motor 401a that functions as an actuator, and a photo-interrupter that detects the origin position of the focus unit 114. In this embodiment, the photo-interrupter functions as a detector. Generally, a stepping motor, which is a type of actuator, is often used as a focus motor. Since a stepping motor can only control a relative driving amount, while the camera body 1 is powered off, the current position of the focus unit 114 is undefined. In this case, the current position of the focus unit 114 cannot be detected.

Even if the camera body 1 remains powered on, assume that electrification to the interchangeable lens 101 is interrupted, for example, by mechanically detaching the interchangeable lens 101 from the camera mount 7 of the camera body 1. In this case, the focus unit 114 is held at the position when the electrification was interrupted and becomes undetectable.

In a case where the user turns on the power operation unit 3 from a state in which the current position of the focus unit 114 is undefined as described above, the focus unit 114 is to be moved to the origin position and origin detecting processing is to be executed before the camera body 1 reaches an imaging standby state.

The focus motor 401a may be a DC motor with an encoder, an ultrasonic motor, a servo motor, or the like. The photo-interrupter receives light emitted from the light emitter directly at the light receiver, but instead of this, a photo-reflector that receives reflected light from a reflective surface or a brush that contacts a conductive pattern to electrically detect a signal may be used as the detector.

The camera control unit 12 controls the driving of the aperture unit 301 and the shutter unit 14 via the aperture drive unit 302 and the shutter drive unit 15 according to the aperture value and shutter speed settings received from the operation unit 11. For example, in a case where an AE control operation is instructed, the camera control unit 12 receives a luminance signal generated by the image processing unit 17 and performs a photometry (light metering) calculation. Based on the photometry calculation result, the camera control unit 12 controls the aperture drive unit 302 according to the imaging instruction operation (such as full pressing of the release button 5) on the operation unit 11. At the same time, the camera control unit 12 controls the driving of the shutter unit 14 via the shutter drive unit 15, and performs exposure processing using the image sensor 16.

The camera body 1 has a pitch shake detector 19 and a yaw shake detector 20 as shake detectors configured to detect image shake such as that caused by a user's manual shake. Each of the pitch shake detector 19 and the yaw shake detector 20 uses an angular velocity sensor (vibration gyro) and an angular acceleration sensor to detect image shake in the pitch direction (rotational direction around the Z-axis) and the yaw direction (rotational direction around the Y-axis), and output a shake signal. The camera control unit 12 uses a shake signal from the pitch shake detector 19 to calculate a shift position of the lens image-stabilizing unit 112 in the Y-axis direction. Similarly, the camera control unit 12 uses a shake signal from the yaw shake detector 20 to calculate a shift position of the lens image-stabilizing unit 112 in the Z-axis direction. The camera control unit 12 then controls the driving of the lens image-stabilizing unit 112 a target position according to the calculated shift position in the pitch/yaw direction, and performs an image stabilizing operation to reduce image blur during exposure or display of a through-image.

The interchangeable lens 101 includes a zoom operation ring 103 configured to change an angle of view of the imaging optical system, and a zoom detector 106 configured to detect an angle of the zoom operation ring 103. The zoom detector 106 uses, for example, a resistive linear potentiometer, and detects the angle of the zoom operation ring 103 operated by the user as an absolute value. Information on the angle of view detected by the zoom detector 106 is transmitted to the lens control unit 104 and reflected in various controls by the camera control unit 12. Some of the information on the various controls is recorded in the memory 13 or a recording medium together with the captured image.

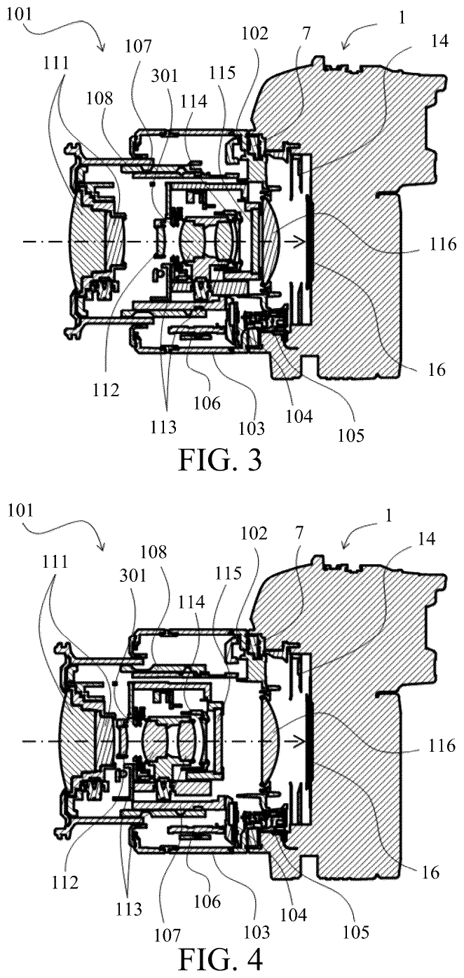

Referring now to FIGS. 3 to 5, a description will be given of a positional relationship among the main components of the interchangeable lens 101. FIGS. 3 to 5 are sectional views on an XY plane including the optical axis of the interchangeable lens 101. A centerline illustrated in each figure approximately coincides with the optical axis determined by the imaging optical system, and therefore it will be synonymous with the optical axis hereinafter. FIG. 3 illustrates a wide-angle end on a short focal length side during zooming, and FIG. 4 illustrates a telephoto end on a long focal length side during zooming.

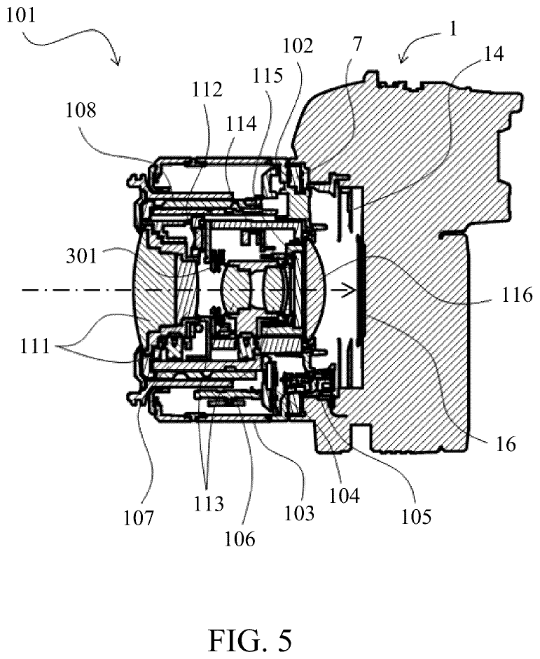

Both FIGS. 3 and 4 illustrate the imaging optical system in the interchangeable lens 101 located at an imageable position (in an imageable state). On the other hand, FIG. 5 illustrates the imaging optical system in the interchangeable lens 101 in a stored state (a state where it is located at a retracted position) during non-imaging. FIG. 5 also illustrates a retracted end, which provides the shortest overall length in the optical axis direction.

The retracted end illustrated in FIG. 5 is provided further beyond the wide-angle end in FIG. 3, and by rotating the zoom operation ring 103 in one direction, the retracted end illustrated in FIG. 5 moves to the wide-angle end illustrated in FIG. 3, and then the zoom position moves from the wide-angle end illustrated in FIG. 3 to the telephoto end illustrated in FIG. 4. In this embodiment, an imageable state of the imaging optical system is defined as a first state, and a state in which the imaging optical system is located in a retracted position is defined as a second state. The imageable state means that the functions of the camera, including the camera body 1 and the interchangeable lens 101, can always operate normally. Restricted imaging means that some of the functions of the camera, including the camera body 1 and the interchangeable lens 101, do not operate normally. For example, in a case where the imaging optical system is located at the retracted position, the imaging action itself (such as pressing the shutter to capture an object) is available, but the captured image may be entirely or partially blurred due to a lack of focus or other causes

As illustrated in FIGS. 3 and 4, this embodiment employs a six-unit configuration as an example imaging optical system. The zoom unit 110 moves to different predetermined use positions at the wide-angle end and the telephoto end to condense light from an object on the image sensor 16. The zoom unit 110 includes a first zoom unit 111, a lens image-stabilizing unit 112 and an aperture unit 301 functioning as a second zoom unit, a third zoom unit 113, a focus unit 114 functioning as a fourth zoom unit, a fifth zoom unit 115, and a sixth zoom unit 116. This embodiment does not limit the configuration of the imaging optical system and, for example, the lens image-stabilizing unit 112 and the focus unit 114 may function as other zoom units. A part of lens units may not be movable and may be fixed.

A linear guide barrel 107 is a fixed part that is fixed to the lens mount 102 via an unillustrated fixed barrel. Unillustrated cam grooves are formed at regular intervals on the outer circumferential surface of the linear guide barrel 107. On the other hand, unillustrated cam followers are provided on the inner circumferential side of a cam barrel 108. The cam barrel 108 is connected to the zoom operation ring 103 via an unillustrated key. In a case where the zoom operation ring 103 is rotated, the cam barrel 108 moves forward and backward in the optical axis direction while rotating around the optical axis due to the engagement between the cam grooves and the cam followers.

The linear guide barrel 107 has linear guide grooves at regular intervals that regulate the movement of the zoom unit 110 in the rotational direction and guide its linear movement in the optical axis direction. The cam barrel 108 also has cam grooves at regular intervals that correspond to the zoom unit 110 and have trajectories at different angles in the rotational direction. The zoom unit 110 is provided with a plurality of cam followers, and each cam follower is engaged with the corresponding linear guide groove and cam groove. In a case where the user rotates the zoom operation ring 103, the cam barrel 108 rotates, and the cam followers move the zoom unit 110 forward and backward in the optical axis direction while regulating their movement in the rotational direction due to the engagement between the linear guide grooves and the cam grooves.

The interchangeable lens 101 according to this embodiment has a retractable structure, which will be described in detail later, and a retreat mechanism for the lens image-stabilizing unit (second zoom unit) 112. Such a configuration can retract the zoom unit 110 further to the rear side (imaging surface side) during non-imaging. Thereby, the overall length of the interchangeable lens 101 can be reduced, and the portability of the interchangeable lens 101 and the camera body 1 can be improved.

At a wide-angle end illustrated in FIG. 3, a distance between the first zoom unit 111 and the lens image-stabilizing unit (second zoom unit) 112 is wide, and at the telephoto end in FIG. 4, a distance between the fifth zoom unit 115 and the sixth zoom unit 116 is wide. The retractable structure narrows each distance, moves them to storage positions close to each other, and reduces the overall length in the optical axis direction. As illustrated in FIG. 5, at the retracted end during non-imaging, the zoom unit 110 moves to a retracted position close to each other. For example, in a case where the user rotates the zoom operation ring 103 to the wide-angle end from this state, the zoom unit 110 extends to the front side (object side), moves to a predetermined use position, and thereby reaches the imageable state as illustrated in FIG. 3.

During imaging illustrated in FIGS. 3 and 4, each component in the zoom unit 110 is disposed on the optical axis, but at the retracted end during non-imaging illustrated in FIG. 5, the lens image-stabilizing unit (second zoom unit) 112 retreats in a direction orthogonal to the optical axis (radial direction). In a case where the user rotates the zoom operation ring 103 from the wide-angle end where imaging is available as illustrated in FIG. 3 toward the retracted end, the zoom unit 110 starts retracting to the rear side (imaging surface side), but at the same time, the lens image-stabilizing unit (second zoom unit) 112 retreats from the optical axis. The first zoom unit 111 is further inserted into the space thus created and stored so as not to interfere with each other, resulting in the state illustrated in FIG. 5 in which the overall length is reduced to the full.

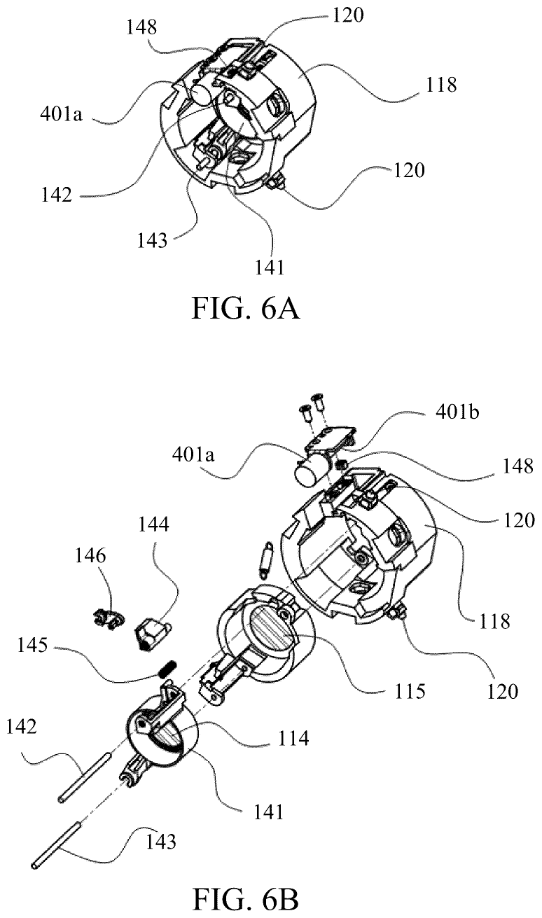

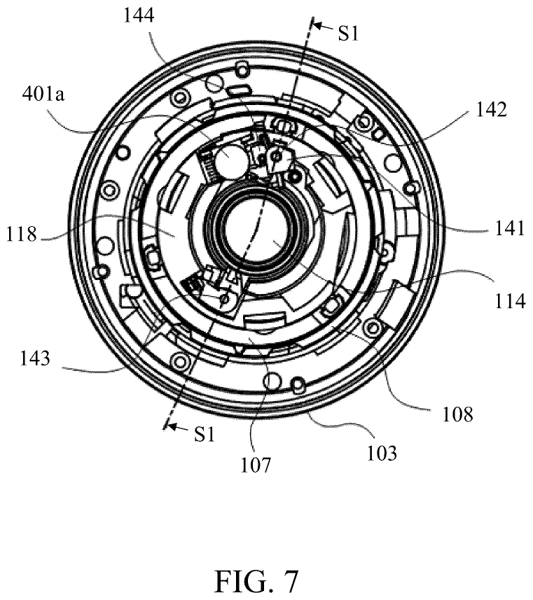

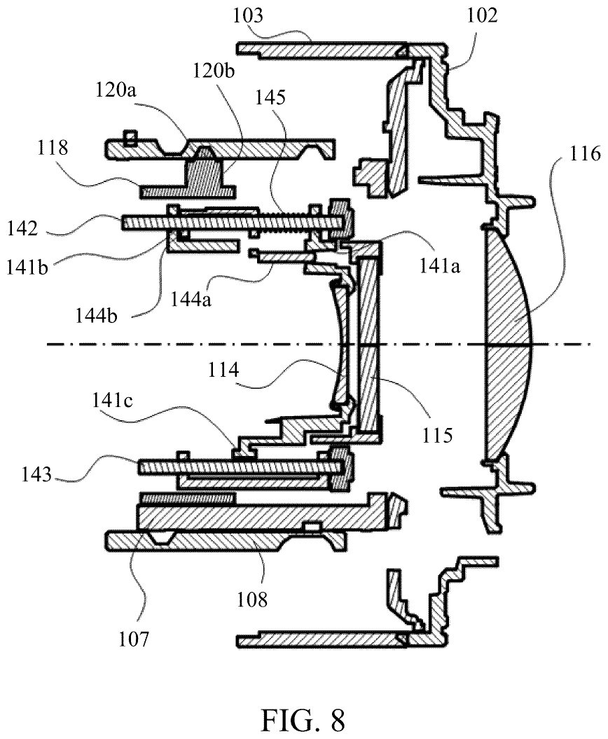

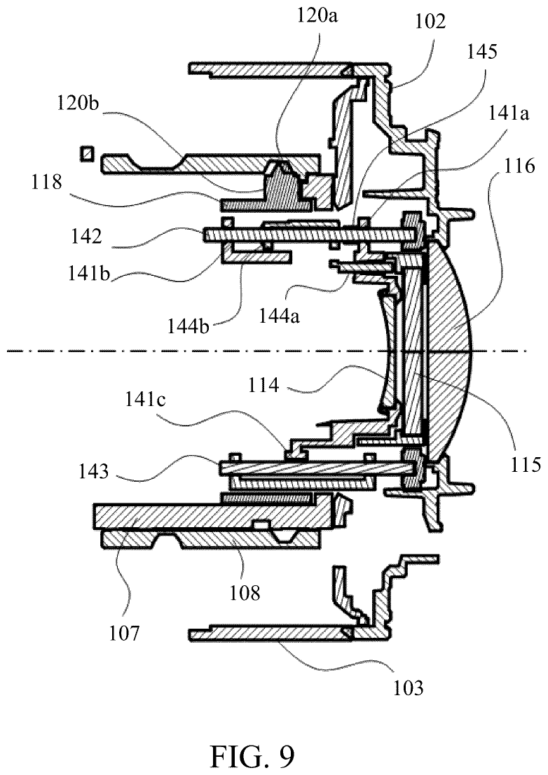

FIG. 6A is a perspective view of the members (components) that constitute the retractable structure according to this embodiment, and FIG. 6B is an exploded perspective view illustrating a part of the components illustrated in FIG. 6A. FIG. 7 is a front view of the retractable structure according to this embodiment, and FIGS. 8 and 9 are sectional views taken along a line S1-S1 in FIG. 7. FIG. 8 illustrates the interchangeable lens 101 at the telephoto end similarly to FIG. 4. FIG. 9 illustrates the interchangeable lens 101 at the retracted end similarly to FIG. 5.

A rear group base barrel 118 houses a focus drive unit 401 that includes a focus motor 401a and a feed screw (engagement portion) 401b, a focus unit holding frame (holding member) 141 that holds the focus unit 114, and the fifth zoom unit 115. The rear group base barrel 118 moves in the optical axis direction integrally with the components during zooming from the wide-angle end to the telephoto end. Three cam followers 120 are provided at regular intervals on the outer circumference of the rear group base barrel 118.

The cam followers 120 are engaged with tapered inner circumferential cam grooves provided in the inner circumference of the cam barrel 108. A cam barrel engagement portion 120a of the cam followers 120 is cone-shaped and is configured to contact (for example, line contact) a slope of the inner circumferential cam groove. A guide barrel engagement portion 120b of the cam followers 120 is engaged with a linear guide groove provided in the linear guide barrel 107. In a case where the zoom operation ring 103 is rotated, the cam barrel 108 connected via the unillustrated key rotates and the rear group base barrel 118 moves in conjunction with the zoom operation ring 103. Thus, in a case where the rear group base barrel 118 moves in the optical axis direction, the state transitions from a first state in which imaging is possible as illustrated in FIG. 8 to a second state in which imaging is restricted by restricting the movement of the focus unit holding frame 141 as illustrated in FIG. 9.

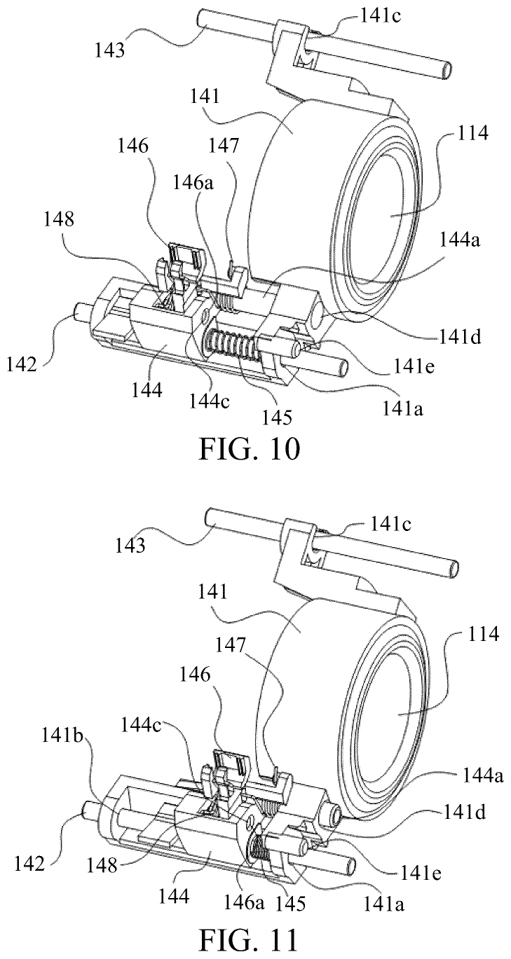

FIGS. 10 and 11 are perspective views illustrating the holding structure for the focus unit 114. FIG. 10 illustrates the telephoto end similarly to FIGS. 4 and 8, and FIG. 11 illustrates the retracted end similarly to FIGS. 5 and 9. A first guide bar (guide member) 142 is a metal member fixed to the rear group base barrel 118, and is engaged with a sliding hole 141a on the imaging surface side and a sliding hole 141b on the object side formed in the focus unit holding frame 141. Similarly, a second guide bar 143 fixed to the rear group base barrel 118 is engaged with a U-shaped groove 141c provided in the focus unit holding frame 141. Thereby, the focus unit holding frame 141 is held movably in the optical axis direction relative to the rear group base barrel 118.

In this embodiment, a rack holder (second intermediate member) 144 and a rack (first intermediate member) 146 constitute an intermediate member that transmits a drive force of the focus drive unit 401 to the focus unit holding frame 141. The rack holder 144 has a through-hole into which the first guide bar 142 is inserted. The rack holder 144 is supported by the first guide bar 142 movably in the axial direction and rotatably on a plane orthogonal to the optical axis. A boss 144a of the rack holder 144 is engaged with an elongated hole 141d provided in the focus unit holding frame 141, and thereby prevents the rack holder 144 from rotating around the through-hole. A compression coil spring (second biasing member) 145 is disposed in space between the focus unit holding frame 141 and the rack holder 144. One end of the compression coil spring 145 biases the focus unit holding frame 141 toward the imaging surface side in the optical axis direction, and the other end biases the rack holder 144 toward the sliding hole 141b side (object side) of the focus unit holding frame 141. Therefore, in a case where the rack holder 144 moves in the optical axis direction, the focus unit holding frame 141 moves integrally (in conjunction) in the same direction.

The rack 146 is engaged with a feed screw 401b provided on the rotation shaft of the focus drive unit 401, and a rotation shaft portion 146a is engaged with an engagement hole 144c in the rack holder 144, and only rotation around an engagement hole 144c is permitted. A coil portion of a torsion coil spring (first biasing member) 147 is inserted into the boss 144a. One end of an arm portion of the torsion coil spring 147 contacts the rack 146 to bias the rack 146 against the feed screw 401b, and the other end of the arm portion contacts the rack holder 144 to bias the rack holder 144 against the elongated hole 141d provided in the focus unit holding frame 141.

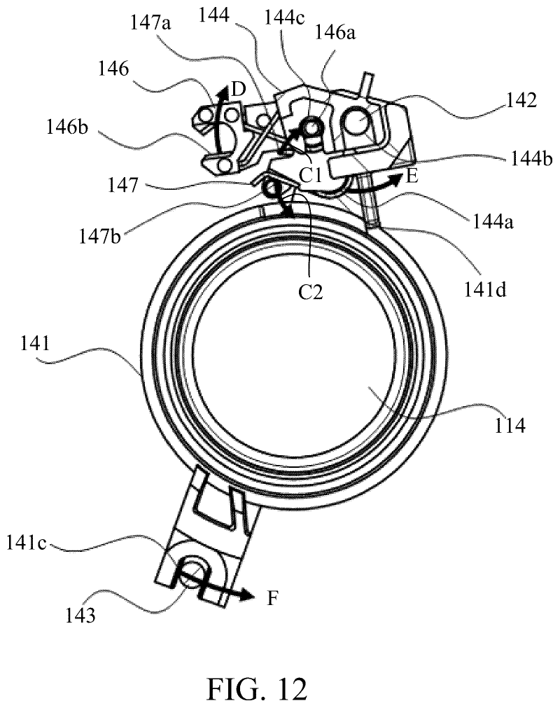

Referring now to FIG. 12, a description will be given of a propagation path of a biasing force acting on the focus unit 114. FIG. 12 is a front sectional view illustrating the holding structure for the focus unit 114. At one end of the torsion coil spring 147, a contact portion 147a with the rack 146 applies a biasing force C1 to the rack 146, and generates a moment around the engagement hole 144c in the rack 146. The moment around the engagement hole 144c applies a biasing force D to the feed screw 401b via engagement teeth 146b of the rack 146. Thereby, the rack 146 and the feed screw 401b are stably engaged without separating, even if the feed screw 401b vibrates due to variations in component accuracy.

At the other end of the torsion coil spring 147, the contact portion 147b with the rack holder 144 applies a biasing force C2 to the rack holder 144, and generates a moment around the first guide bar 142 in the rack holder 144. The moment around the first guide bar 142 applies a biasing force E to the elongated hole 141d provided in the focus unit holding frame 141 via the boss 144a. The biasing force E generates a moment around the first guide bar 142 in the focus unit holding frame 141, which applies a biasing force F to the second guide bar 143 engaged with the U-shaped groove 141c provided in the focus unit holding frame 141. Thereby, the focus unit holding frame 141 is always biased to one side of the gap between the first guide bar 142 and the second guide bar 143, and the position and tilt of the focus unit holding frame 141 in a plane orthogonal to the optical axis can be stabilized.

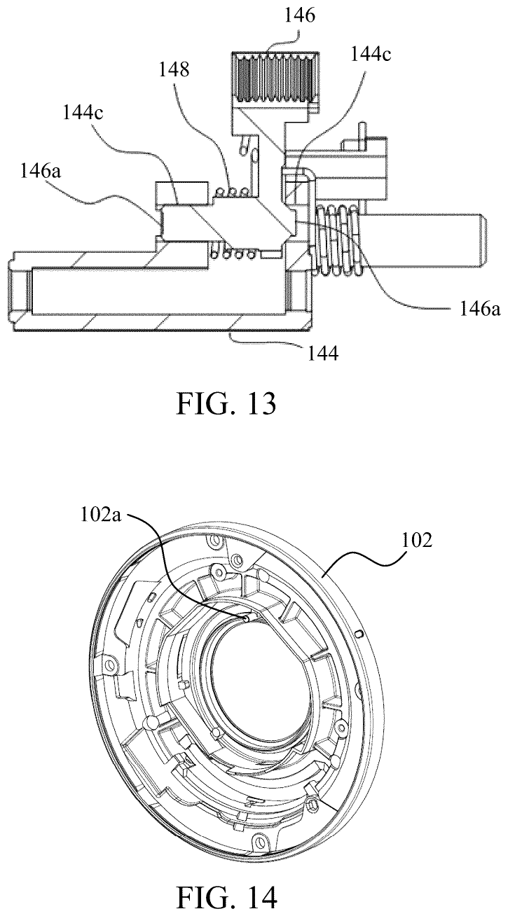

FIG. 13 is a sectional view illustrating the holding structure for the rack 146. The rack 146 has both ends of the rotation shaft portion 146a engaged with the engagement hole 144c in the rack holder 144. One of the rotation shaft portion 146a of the rack 146 has a contact portion having a conical shape with the engagement hole 144c of the rack holder 144, and is in line contact with the engagement hole 144c. A spring 148 is inserted into space between the other of the rotation shaft portion 146a of the rack 146 and the engagement hole 144c in the rack holder 144, and biases the rack 146 to the rack holder 144. In a case where the rotation axis of the rack 146 and the feed screw 401b of the focus drive unit 401 are tilted in different directions, the rack holder 144 falls around the conical shape of the rack holder 144 in accordance with the tilt of the feed screw 401b. In addition, the biasing force of the spring 148 keeps the conical shape of the rack holder 144 and the engagement hole 144c in contact with each other without being separated. Thereby, the rack 146 and the feed screw 401b can be reliably engaged, and the rotational drive force of the focus motor 401a can be stably converted into propulsion force in the optical axis direction.

FIG. 14 is a perspective view of the lens mount 102 viewed from the object side, and illustrates the location of a contact portion 102a that contacts a contact portion 141e of the focus unit holding frame 141 in the retraction. At the telephoto end, the biasing force of the compression coil spring 145 causes an end portion 144b to contact the sliding hole 141b on the object side, and the rack holder 144 and the focus unit holding frame 141 to integrally move.

On the other hand, at the retracted end, the rear group base barrel 118 moves in the optical axis direction toward the imaging surface opposite the object side, and the contact portion 141e on the focus unit holding frame 141 contacts the contact portion 102a on the lens mount 102. At this time, the rack 146 is engaged with the feed screw 401b and does not move, so the compression coil spring 145 is compressed, and the focus unit holding frame 141 can move relative to the rear group base barrel 118. At this time, the focus unit holding frame 141 can be separated from the rack holder 144 against the biasing force of the compression coil spring 145. By separating the focus unit holding frame 141 from the rack holder 144, the first state transitions to the second state.

Thus, by applying a biasing force by the torsion coil spring 147 between the rack 146 and the rack holder 144, the rack 146 and the feed screw 401b can always stably contact each other without being separated. This configuration can improve the responsiveness and accuracy of the moving amount of the rack 146 in the optical axis direction relative to the rotational drive amount by the focus motor 401a. The focus unit holding frame 141 is always moved to one side relative to the first guide bar 142 and the second guide bar 143, and there is no gap between them, so that the position and tilt of the focus unit holding frame 141 in a plane direction orthogonal to the optical axis can be stabilized. Thereby, even if the attitude of the interchangeable lens 101 and thereby the gravity direction changes, the position of the focus unit holding frame 141 does not change and high positional accuracy can be maintained. The focus unit holding frame 141 can be separated from the rack holder 144 by the compression coil spring 145 disposed between the focus unit holding frame 141 and the rack holder 144. That is, in an area where the first state can be transitioned to the second state and there is no restriction by the first state or the second state, when the rack holder 144 moves in the optical axis direction, the focus unit holding frame 141 can move integrally (in conjunction) in the same direction. Thereby, high trackability of the rack holder 144 and the focus unit holding frame 141 can be ensured. In addition, in a case where the focus unit 114 is subjected to an impact due to a fall or vibration, the compression coil spring 145 contracts to reduce the impact on the focus unit 114 and the load on the rack 146, suppressing tooth skipping and damages to the focus unit 114 and the rack 146. Furthermore, the rack 146 can rotate relative to the rack holder 144 and follow the tilt of the feed screw 401b of the focus drive unit 401, so that the rack 146 and the feed screw 401b can be reliably engaged. Thereby, tooth skipping and local wear of the rack 146 can be suppressed. Thus, an interchangeable lens (optical apparatus) 101 that can maintain optical holding accuracy in a retractable configuration can be provided.

This embodiment has illustrated the holding structure for the focus unit 114, but is not limited to this example, and another lens unit that constitutes the imaging optical system, such as the zoom unit 110 and the lens image-stabilizing unit 112, may also have a similar holding structure. The zoom operation ring 103 can be rotated by the user to switch between an imageable state and a retracted state, but this embodiment is not limited to this example, and a method other than a manual operation, such as a method using an electric actuator, may be used.

### Second Embodiment

The basic configuration of a camera system according to this embodiment is similar to that of the camera system according to the first embodiment. This embodiment will discuss only the configuration different from that of the first embodiment and will omit a description of the common configuration.

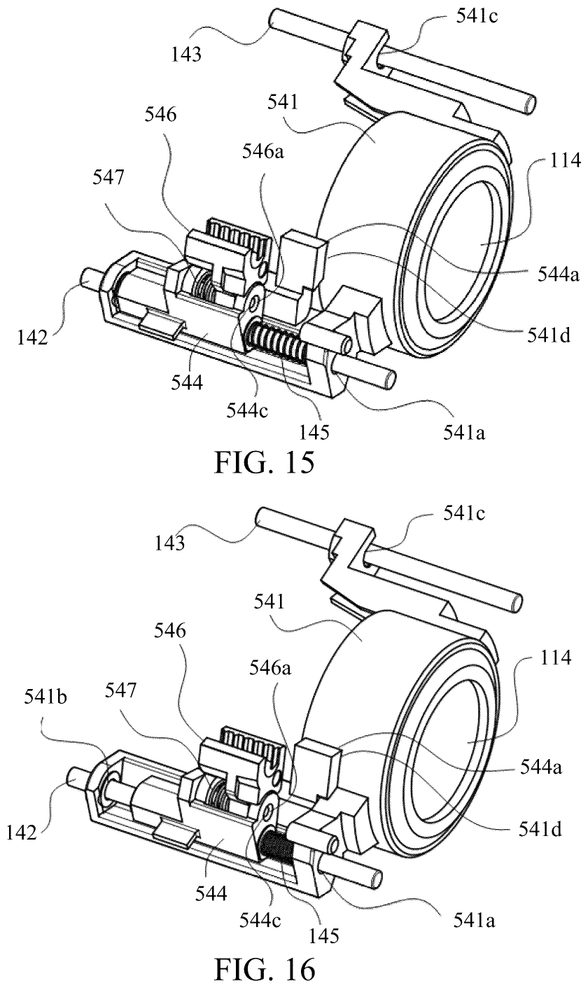

FIGS. 15 and 16 are perspective views illustrating the holding structure for the focus unit 114. FIG. 15 illustrates the telephoto end similarly to FIGS. 4 and 8, and FIG. 16 illustrates the retracted end similarly to FIGS. 5 and 9. The first guide bar 142 is a metal member fixed to the rear group base barrel 118, and is engaged with a sliding hole 541a on the imaging surface side and a sliding hole 541b on the object side formed in a focus unit holding frame 541. Similarly, the second guide bar 143 fixed to the rear group base barrel 118 is engaged with a U-shaped groove 541c provided in the focus unit holding frame 541. Thereby, the focus unit holding frame 541 is held movably in the optical axis direction relative to the rear group base barrel 118.

In this embodiment, a rack holder (second intermediate member) 544 and a rack (first intermediate member) 546 constitute an intermediate member that transmits a drive force of the focus drive unit 401 to the focus unit holding frame 141. The rack holder 544 has a through-hole into which the first guide bar 142 is inserted. The rack holder 544 is supported by the first guide bar 142 movably in the axial direction and rotatably on a plane orthogonal to the optical axis. A protrusion portion 544a of the rack holder 544 contacts a contact surface 541d provided on the focus unit holding frame 541, and prevents the rack holder 544 from rotating around the through-hole. The compression coil spring (second biasing member) 145 is disposed in space between the focus unit holding frame 541 and the rack holder 544. One end of the compression coil spring 145 biases the focus unit holding frame 541 toward the imaging surface side in the optical axis direction, and the other end biases the rack holder 544 toward the sliding hole 541b side (object side) of the focus unit holding frame 541. Therefore, in a case where the rack holder 544 moves in the optical axis direction, the rack 546 moves integrally (in conjunction) in the same direction.

The rack 546 is engaged with the feed screw 401b provided on the rotation shaft of the focus drive unit 401, and a rotation shaft portion 546a is engaged with an engagement hole 544c in the rack holder 544, and only rotation around the engagement hole 544c is permitted. A torsion coil spring (first biasing member) 547 has a coil portion inserted into the rotation shaft portion 546a of the rack 546. One end of an arm portion of the torsion coil spring 547 contacts the rack 546 to bias the rack 546 against the feed screw 401b, and the other end of the arm portion contacts the rack holder 544 to bias the rack holder 544 against a contact surface 541d provided on the focus unit holding frame 541.

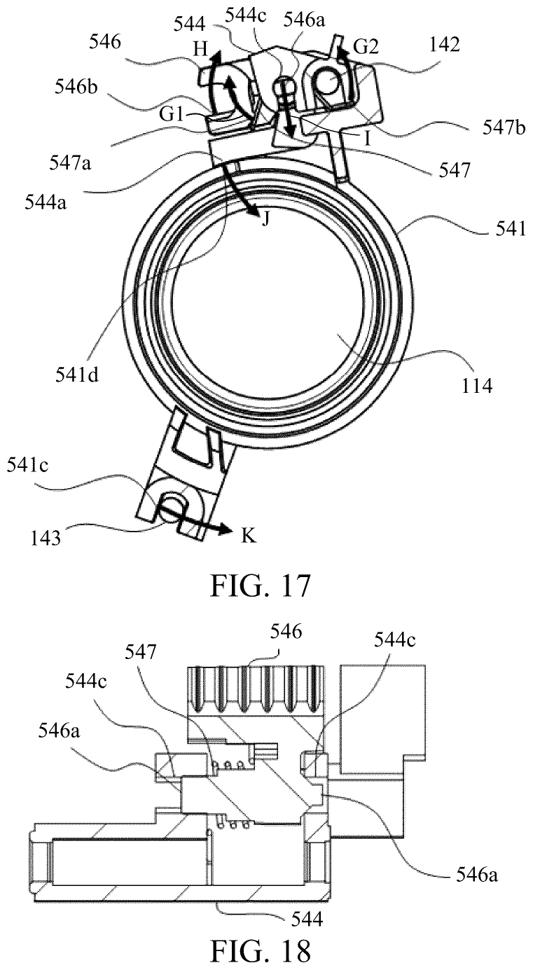

Referring now to FIG. 17, a description will be given of the propagation path of the biasing force acting on the focus unit 114. FIG. 17 is a front sectional view illustrating the holding structure for the focus unit 114. At one end of the torsion coil spring 547, a biasing force G1 is applied to the rack 546 by the contact portion 547a with the rack 546, and a moment about the engagement hole 544c is generated in the rack 546. The moment about the engagement hole 544c applies a biasing force H to the feed screw 401b via the engagement teeth 546b of the rack 546. Thereby, even if the feed screw 401b vibrates due to variations in component accuracy, the rack 546 and the feed screw 401b can be stably engaged without being separated.

At the other end of the torsion coil spring 547, a biasing force G2 is applied to the rack holder 544 via the contact portion 547b with the rack holder 544. A biasing force I is applied to the rotation shaft portion 546a of the rack 546 from the coil portion of the torsion coil spring 547 by receiving the reaction force of the biasing forces G1 and G2, and a moment about the first guide bar 142 is generated in the rack holder 544. The moment about the first guide bar 142 applies a biasing force J to the contact surface 541d provided on the focus unit holding frame 541 via the protrusion portion 544a. The biasing force J generates a moment around the first guide bar 142 on the focus unit holding frame 541, which applies a biasing force K to the second guide bar 143 engaged with the U-shaped groove 541c provided on the focus unit holding frame 541. Thereby, the focus unit holding frame 514 is always shifted to one side relative to the gap between the first guide bar 142 and the second guide bar 143, and the position and tilt of the focus unit holding frame 514 in a plane orthogonal to the optical axis can be stabilized.

FIG. 18 is a sectional view illustrating the holding structure for the rack 546. Both ends of the rotation shaft portion 546a of the rack 546 are engaged with the engagement hole 544c in the rack holder 544. One side of the rotation shaft portion 546a of the rack 546 has a contact portion having a conical shape with the engagement hole 544c in the rack holder 544, and is in line contact with the engagement hole 544c. The torsion coil spring 547 is inserted into space between the other end of the rotation shaft portion 546a of the rack 546 and the engagement hole 544c of the rack holder 544, and biases the rack 546 toward the rack holder 544. In a case where the rotation axis of the rack 546 and the feed screw 401b of the focus drive unit 401 are tilted in different directions, the rack holder 544 falls around the conical shape of the rack holder 544 in accordance with the tilt of the feed screw 401b. Due to the biasing force by the torsion coil spring 547, the conical shape of the rack holder 544 and the engagement hole 544c always contact each other without being separated. Thereby, the rack 546 and the feed screw 401b are reliably engaged, and the rotational drive force of the focus motor 401a can be stably converted into a propulsive force in the optical axis direction.

Thus, by applying a biasing force by the torsion coil spring 547 between the rack 546 and the rack holder 544, the rack 546 and the feed screw 401b can always stably contact each other without being separated. This configuration can improve the responsiveness and accuracy of the moving amount of the rack 546 in the optical axis direction relative to the rotational drive amount by the focus motor 401a. The focus unit holding frame 541 is always biased to one side of the gap between the first guide bar 142 and the second guide bar 143, and the position and tilt of the focus unit holding frame 541 in a plane direction orthogonal to the optical axis can be stabilized. Thereby, even if the attitude of the interchangeable lens 101 and thereby the gravity direction changes, the position of the focus unit holding frame 541 does not change and high positional accuracy to be maintained. In addition, due to the compression coil spring 145 disposed between the focus unit holding frame 541 and the rack holder 544, the focus unit holding frame 541 can be separated from the rack holder 544. That is, in an area where the first state can be transitioned to the second state and where there is no restriction of the first state or the second state, when the rack holder 544 moves in the optical axis direction, the focus unit holding frame 541 can move integrally (in conjunction) in the same direction. Thereby, high trackability between the rack holder 544 and the focus unit holding frame 541 can be ensured. In addition, in a case where the focus unit 114 is subjected to an impact due to a fall or vibration, the compression coil spring 145 contracts to reduce the impact received by the focus unit 114 and the load on the rack 546, suppressing tooth skipping and damages to the focus unit 114 and the rack 546. Furthermore, the rack 546 can rotate relative to the rack holder 544 and follow the tilt of the feed screw 401b of the focus drive unit 401, so that the rack 546 and the feed screw 401b can be reliably engaged. Thereby, tooth skipping and local wear of the rack 546 can be suppressed. Thus, an interchangeable lens (optical apparatus) 101 that can maintain optical holding accuracy in a retractable configuration can be provided.

This embodiment has illustrated the holding structure for the focus unit 114, but is not limited to this example, and another lens unit that constitutes the imaging optical system, such as the zoom unit 110 and the lens image-stabilizing unit 112, may also have a similar holding structure. The zoom operation ring 103 can be rotated by the user to switch between an imageable state and a retracted state, but this embodiment is not limited to this example, and a method other than a manual operation, such as a method using an electric actuator, may be used.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide an optical apparatus that has a retractable structure and can maintain optical holding accuracy.

This application claims priority to Japanese Patent Application No. 2024-020803, which was filed on Feb. 15, 2024, and which is hereby incorporated by reference herein in its entirety.

What is claimed is:

1. An optical apparatus comprising:
a holding member configured to hold an optical system;
a drive unit configured to move the holding member;
an intermediate member including a first intermediate member in contact with the drive unit, and a second intermediate member in contact with the first intermediate member and the holding member, the intermediate member being configured to transmit a drive force of the drive unit to the holding member; and
a first biasing member configured to bias the first intermediate member toward the drive unit and bias the second intermediate member toward the holding member.

2. The optical apparatus according to claim 1, wherein the first biasing member biases the first intermediate member and the second intermediate member in a direction orthogonal to an optical axis of the optical system.

3. The optical apparatus according to claim 1, further comprising a second biasing member configured to bias the holding member toward the second intermediate member in a direction along an optical axis of the optical system,
wherein the optical apparatus has a first state in which a part of the holding member contacts the second intermediate member in accordance with a biasing force of the second biasing member, and a second state in which the holding member is separated from the second intermediate member against the biasing force of the second biasing member.

4. The optical apparatus according to claim 3, wherein the first state is a state in which the optical system is located at an imageable position.

5. The optical apparatus according to claim 3, wherein the second state is a state in which the optical system is in a retracted position in which imaging is restricted.

6. The optical apparatus according to claim 3, further comprising a base barrel configured to hold the holding member movably in the direction along the optical axis of the optical system,
wherein the base barrel moves in the direction along the optical axis and thereby transitions the first state to the second state.

7. The optical apparatus according to claim 6, further comprising a fixed member that includes a contact portion that contacts the holding member,
wherein in a case where the base barrel moves toward an imaging surface side in the direction along the optical axis, the contact portion separates the holding member from the second intermediate member against the biasing force of the second biasing member.

8. The optical apparatus according to claim 6, further comprising an operation member rotatable in a radial direction around the optical axis of the optical system,
wherein the base barrel moves in the direction along the optical axis in conjunction with a rotation of the operation member.

9. The optical apparatus according to claim 1, further comprising a guide member configured to guide the holding member in a direction along an optical axis of the optical system,
wherein the guide member rotatably supports the second intermediate member on a plane orthogonal to the optical axis and guides the second intermediate member in the direction along the optical axis.

10. The optical apparatus according to claim 9, wherein at least a part of an area in which the guide member supports the second intermediate member overlaps an area in which the guide member holds the holding member in the direction along the optical axis.

11. The optical apparatus according to claim 1, wherein the first intermediate member is engaged with a screw provided on a rotation shaft of the drive unit, and
wherein the second intermediate member moves in a direction along an optical axis of the optical system in conjunction with a movement of the first intermediate member.

12. The optical apparatus according to claim 1, wherein the optical system includes a focus lens, and
wherein the drive unit performs focusing by moving the focus lens in a direction along an optical axis of the optical system.

13. The optical apparatus according to claim 1, wherein the optical apparatus is an interchangeable lens.

14. A camera system comprising:
a camera body that includes a camera mount and a power supply unit;
an optical apparatus that includes a lens mount connectible to the camera mount,
wherein optical apparatus includes:
a holding member configured to hold an optical system;
a drive unit configured to move the holding member;
an intermediate member including a first intermediate member in contact with the drive unit, and a second intermediate member in contact with the first intermediate member and the holding member, the intermediate member being configured to transmit a drive force of the drive unit to the holding member; and
a first biasing member configured to bias the first intermediate member toward the drive unit and bias the second intermediate member toward the holding member, and
wherein the power supply unit supplies power to the camera body and the optical apparatus.
